(19) United States
(12) Patent Application Publication
(10) Pub. No.: US 2024/0209221 A1
(43) Pub. Date: Jun. 27, 2024

(54) Laminate and Coating Composition

(71) Applicant: 3M INNOVATIVE PROPERTIES COMPANY, St. Paul, MN (US)

(72) Inventors: Hiroyuki Kobayashi, Tokyo (JP); Yu-Chih Lin, Taoyuan City (TW); Naota Sugiyama, St. Paul, MN (US)

(21) Appl. No.: 18/553,630

(22) PCT Filed: Mar. 28, 2022
(86) PCT No.: PCT/IB2022/052852

§ 371 Date: Oct. 2, 2023

(30) Foreign Application Priority Data
Apr. 12, 2021 (JP) 2021-067307

(51) Int. Cl. C09D 7/62; C08J 7/04; C08J 7/043; C08J 7/056; C08K 3/36; C09D 4/06; C09D 7/63; C09D 133/10

(52) U.S. Cl. CPC C09D 7/62; C08J 7/0423; C08J 7/043; C08J 7/056; C08K 3/36; C09D 4/06; C09D 7/63; C09D 133/10; C08J 2333/10

(57) ABSTRACT

Provided is a laminate that may exhibit thermally stable hydrophilicity, and a coating composition that may be used for such a laminate. A laminate according to one embodiment of the present disclosure includes: a substrate; a first layer disposed on at least one surface of the substrate, the first layer including a binder and an inorganic nanoparticle; and a hydrophilic second layer disposed on the first layer, the binder containing a cured product of a binder precursor containing 30 mass % or greater of a tri- or higher functional (meth)acrylate monomer relative to a total amount of the binder, and the inorganic nanoparticle having a (meth)acryloyl group.

### TECHNICAL FIELD

The present disclosure relates to a laminate and a coating composition.

### BACKGROUND

In recent years, various articles having hydrophilic properties have been developed in a wide range of fields such as, building material and medical fields.

Patent Document 1 (JP 2018-180099 A) describes a hydrophilic hard coat laminate including a substrate and a hydrophilic hard coat layer, the hydrophilic hard coat laminate having an initial water contact angle of 20 degrees or less, in which the hydrophilic hard coat layer contains a hydrophilic binder and 60 mass % or greater of inorganic nanoparticles based on the total weight of the hydrophilic hard coat laver, the inorganic nanoparticles being dispersed in the hydrophilic binder.

Patent Document 2 (JP 2020-185700 A) discloses a flow path device for use in the field of biochemical analysis, the device being internally provided with a flow path for allowing a liquid to flow, and the device is formed by a production method including: preparing two or more members as members constituting the flow path device, and forming a hydrophilic coating film in at least one member of the members, using a treatment liquid including a hydrophilizing agent, the hydrophilic coating film covering a surface of the member at a side to be joined to another member; selectively irradiating only a joining surface of the hydrophilic coating film with ultraviolet rays or plasma derived from an oxygen-containing gas in a member having the hydrophilic coating film, and irradiating at least the joining surface with ultraviolet rays or plasma derived from an oxygen-containing gas in a member in which no hydrophilic coating film has been formed in the coating film formation; and applying an external force to the two or more members disposed in predetermined positions such that the joining surfaces of the two or more members treated with ultraviolet rays or plasma face each other, so as to compression bond the joining surfaces.

### CITATION LIST

### Patent Literature

Patent Document 1: JP 2018-180099 A
Patent Document 2: JP 2020-185700 A

### SUMMARY

### Technical Problem

An article having hydrophilicity may be required to stably maintain its high hydrophilicity performance for a long period of time. For example, in a flow path device that may be used in the field of biochemical analyses, changes in the hydrophilic properties of an interface may affect fluid flowability. Furthermore, in the producing process or during its use, it may be subjected to a high temperature environment or a long-term stability evaluation of the constituent members, or may be subjected to a heat aging acceleration test under the high temperature condition. In such a case, the hydrophilicity of the article cannot be stably maintained for a long period of time, and the hydrophilic performance may be reduced.

The present disclosure provides a laminate that exhibits thermally stable hydrophilicity, and a coating composition that may be used for such a laminate.

### Solution to Problem

According to one embodiment of the present disclosure, provided is a laminate including a substrate; a first layer disposed on at least one surface of the substrate, the first layer including a binder and an inorganic nanoparticle; and a second layer that is hydrophilic, the second layer being disposed on the first layer, the binder containing a cured product of a binder precursor, the binder precursor containing 30 mass % or more of a tri- or higher functional (meth)acrylate monomer relative to a total amount of the binder, and the inorganic nanoparticle having a (meth)acryloyl group.

According to another embodiment of the present disclosure, provided is an article including the laminate.

According to another embodiment of the present disclosure, provided is a coating composition including a binder precursor and an inorganic nanoparticle, the binder precursor containing 30 mass % or more of tri- or higher functional (meth)acrylate monomer relative to a total amount of the binder precursor, the inorganic nanoparticle having a (meth)acryloyl group, wherein the coating composition forms a layer on which the hydrophilic layer is applied.

### Advantageous Effects of Invention

According to the present disclosure, it is possible to provide a laminate that exhibits thermally stable hydrophilicity, and a coating composition that may be used in such a laminate.

The above description will not be construed to mean that all embodiments of the present invention and all advantages of the present invention are disclosed.

### BRIEF DESCRIPTION OF THE DRAWINGS

FIG. 1 is a schematic cross sectional view of a laminate according to one embodiment of the present disclosure.

### DETAILED DESCRIPTION

Representative embodiments of the present invention will now be described in greater detail with reference to the drawings as necessary to illustrate the embodiments, but the present invention is not limited to these embodiments.

In the present disclosure. “hydrophilicity” means the performance in which a water contact angle of a hydrophilic target site is lower than a water contact angle of a substrate.

In the present disclosure, “high temperature” can mean, for example, a temperature of approximately 40° C. or higher, approximately 45° C. or higher, approximately 50° C. or higher, approximately 70° C. or higher, or approximately 90° C. or higher. An upper limit value of the high temperature is not particularly limited, and can be, for example, approximately 250° C. or lower, approximately 200° C. or lower, approximately 150° C. or lower, approximately 120° C. or lower, or approximately 100° C. or lower.

In the present disclosure, “(meth)acryl” means acryl or methacryl, “(meth)acrylate” means acrylate or methacrylate, and “(meth)acryloyl” means “acryloyl” or “methacryloyl.”

As used herein, “curing” may include the concepts commonly referred to as “crosslinking.”

As used herein, a “film” also encompasses an article referred to as a “sheet”.

In the present disclosure, for example, “disposed” as in “an adhesive layer disposed under a substrate” is intended to mean that the adhesive layer is disposed directly on the side of the substrate or that the adhesive layer is indirectly disposed on the side of the substrate via another layer.

In the present disclosure, “transparent” means that the total light transmittance measured in accordance with JIS K 7361-1 (1997) is approximately 80% or more, preferably approximately 85% or more, or approximately 90% or more. The upper limit value of the total light transmittance is not particularly limited and, for example, can be approximately less than 100%, approximately 99% or less, or approximately 98% or less.

In the present disclosure, “translucent” means that the total light transmittance measured in a visible light region measured in accordance with JIS K 7361-1 (1997) is lower than 80%, and the average transmittance may be desirably 75% or lower, and “translucent” is intended to mean not completely concealing an underlying layer.

In one embodiment, the laminate of the present disclosure includes a substrate, a first layer disposed on at least one surface of the substrate, including a binder and inorganic nanoparticles having a (meth)acryloyl group; and a hydrophilic second layer disposed in the first layer. The first layer and the second layer may each independently be configured to include a single layer or a laminated structure.

When improving the thermal stability of a layer exhibiting hydrophilicity (sometimes referred to simply as a “hydrophilic layer”), it is usually common to consider the materials that constitute the hydrophilic layer itself. However, the inventors have found that the layers disposed between the hydrophilic layer and the substrate, that is, the first layer of the present disclosure, have been found to contribute to thermal stability of the hydrophilic layer. The fact that the hydrophilic layer is thermally stable in a heat aging acceleration test or the like may mean that the hydrophilic performance of the hydrophilic layer can be stably maintained for a long period of time, for example, in a usage environment at room temperature.

The present inventors focused on a first layer disposed between a hydrophilic layer and a substrate. At least the outermost surface of the first layer may be slightly deformed due to stress relaxation or the like from heat or its secondary effect. When the hydrophilic layer is applied to the first layer, and the surface deformation caused by heat occurs in the first layer, it is considered that the hydrophilic layer disposed in the first layer simultaneously deforms. As a result, for example, it is considered that the hydrophilic performance of the hydrophilic layer decreases because a portion of the first layer appears to the outermost surface. Additionally, when the inorganic nanoparticles are included in the first layer, such surface deformation may be more likely to occur The first layer of the present disclosure disposed between the hydrophilic layer and the substrate includes a binder and inorganic nanoparticles having a (meth)acryloyl group, and further, the binder contains a cured product of a binder precursor containing 30 mass % or more of a tri- or higher functional (meth)acrylate monomer relative to a total amount of the binder, and the inorganic nanoparticles have a (meth)acryloyl group. Therefore, the crosslinking density of the binder increases, and the surface deformation of the first layer is less likely to occur, and also by modifying the reactive group ((meth)acryloyl group) capable of bonding to the binder on the inorganic nanoparticle surface, the binder and the inorganic nanoparticles are bound to each other, and shrinkage and the like generated at the time of curing can be suppressed to a minimum, so that elongation or shrinkage of the first layer due to heat is considered to be restricted. As a result, for the first layer of the present disclosure, plastic deformation on the surface of the first layer can be reduced or prevented, and at the same time, the plastic deformation of the second layer disposed in the first layer can also be reduced or prevented, so that thermal stability of the hydrophilic second layer can be improved.

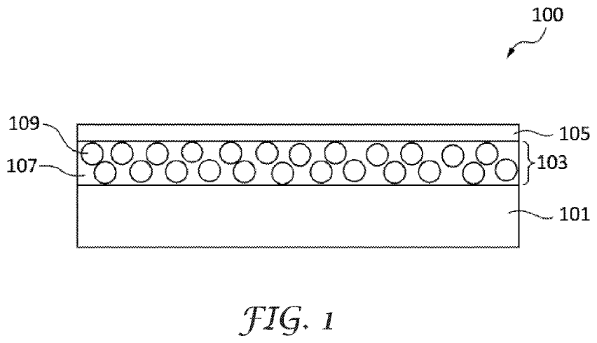

FIG. 1 is a schematic cross sectional view of a laminate according to one embodiment of the present disclosure. A laminate 100 of FIG. 1 includes a substrate 101, a first layer 103, and a hydrophilic second layer 105. The first layer 103 disposed on the substrate 101 includes inorganic nanoparticles 109 having a binder 107 and a reactive group ((meth)acryloyl group) of which at least a portion can be bonded to the binder. In FIG. 1, the first layer 103 and the second layer 105 are formed on one side of the substrate 101, but these may be formed on both sides of the substrate 101. Alternatively, the adhesive layer may be applied to the surface of the substrate 101 on the side opposite the second layer 105 side.

Examples of the binder include a resin having a urethane bond such as a (meth)acrylic resin and a urethane resin, a resin having a urea bond such as a urea resin, and a resin obtained by using an ene-thiol compound type represented by a polythiol compound. Among them, from the viewpoint of reducing or preventing plastic deformation of the first layer, that is, from the viewpoint of thermal stability of the hydrophilic layer (second layer), a (meth)acrylic resin and a resin having a urethane bond are preferable, and a (meth)acrylic resin is more preferable. Here, in the present disclosure, the term “resin having a urethane bond” may include, for example, a resin prepared using urethane (meth)acrylate other than the urethane resin, and the urethane resin can also include a (meth)acrylic urethane resin, and the like. The “ene-thiol compound type” can include a thiol compound and an ene compound. Examples of the thiol compound include a monofunctional, bifunctional, trifunctional, or tetrafunctional primary thiol and secondary thiol. Examples of the ene compound include, but are not limited to, a monofunctional, bifunctional, trifunctional, or tetrafunctional allyl ether. The binder can be used alone, or in combination of two or more. Further, the isocyanate compound can be added as a crosslinking component.

The content of the binder can be, for example, approximately 10 mass % or greater, approximately 13 mass % or greater, approximately 15 mass % or greater, or approximately 17 mass % or greater, and can be, for example, less than approximately 50 mass %, approximately 45 mass % or less, approximately 40 mass % or less, approximately 35 mass % or less, or approximately 30 mass % or less, based on the total weight (dry coating amount) of the first layer, from the viewpoint of adhesion to the hydrophilic layer, shrinkage of the first layer during curing, and scratch resistance of the resulting laminate.

The binder is prepared using a binder precursor containing 30 mass % or more of a tri- or higher functional (meth)acrylate monomer relative to the total amount of the binder precursor. Such monomers can be used alone or in combination of two or more. The use of the tri- or higher functional (meth)acrylate monomer can improve the hardness of the first layer, and thus can contribute to improving performance such as scratch resistance. Here, in the present disclosure, the “binder precursor” refers to a component that ultimately becomes a binder in the first layer, and examples thereof include a curable or crosslinkable monomer and/or a curable or crosslinkable oligomer, and a resin that is cured or crosslinked in advance.

The tri- or higher functional (meth)acrylate monomer is, for example, an organic compound having three or more (meth)acryloyl groups in one molecule. An upper limit value of the number of (meth)acryloyl groups may be, for example, 10 or less. 6 or less, 5 or less, or 4 or less. In general, when the number of functional groups of the (meth)acrylate monomer, that is, the number of (meth)acryloyl groups is large, the crosslinking density increases and the cured product is not easily deformed, which can be considered to contribute to the stable hydrophilic performance of the obtained laminate.

As the tri- or higher functional (meth)acrylate monomer, from the viewpoint of thermal stability of the hydrophilic layer or the like, the (meth)acryloyl equivalent of such a monomer is preferably approximately 80 or greater, approximately 85 or greater, approximately 90 or greater, approximately 95 or greater, or approximately 100 or greater, and is preferably approximately 700 or less, approximately 650 or less, approximately 600 or less, approximately 550 or less, approximately 500 or less, approximately 450 or less, approximately 400 or less, or approximately 350 or less. Here, the (meth)acryloyl equivalent is a value obtained by dividing the molecular weight of the (meth)acrylate monomer by the number of (meth)acryloyl groups, that is, a value calculated by (meth)acryloyl equivalent=Mw/N (Mw: molecular weight, N: number of (meth)acryloyl groups). In general, when the number of the (meth)acryloyl equivalents is reduced, the crosslinking density increases and the cured product is not easily deformed, which can be considered to contribute to the stable hydrophilic performance of the obtained laminate.

From the viewpoint of the thermal stability and the like of the hydrophilic layer, the central skeleton of such a monomer preferably has a cyclic structure or a branched structure as a tri- or higher functional (meth)acrylate monomer. The cyclic structure is preferably a structure other than an aromatic ring, and more preferably a cyclic structure formed of C, O, and N. Examples of the monomer having a cyclic structure include tris[2-((meth)acryloyloxy)ethyl] isocyanurate, and examples of the monomer having a branched structure include trimethylolpropane tri(meth)acrylate. Here, the thermal stability and the like of the hydrophilic layer are adjusted by appropriately selecting the chemical structure of the monomer while considering the resistance to stress concentration of the obtained laminate or a change due to external heat and the like. In general, when the central skeleton of the monomer has a cyclic structure (rigid chemical structure), a hard film can be obtained, and thus a stable hydrophilic performance can be imparted to the obtained laminate as the thermal stability is high. On the other hand, when the monomer contains a long-chain chemical structure, the flexibility of the film is high, and stress concentration can be reduced.

As the tri- or higher functional (meth)acrylate monomer, an ethoxylated, alkoxylated, propoxylated, caprolactone-modified, or urethane-modified monomer can be used. In addition, the number of repeating units at the modification site can be changed. In one embodiment, the total number of repeating units of the modification site can be 40 or less, 30 or less, 20 or less, or 10 or less, and can be 0 or more, or 1 or more. When the number of repeating units at the modification site is large, the flexibility tends to increase, and internal stress is easily relaxed, but on the other hand, deformation may be easily caused by stress due to external heat or the like. In addition, from the viewpoint of the thermal stability of hydrophilicity, the total number of repeating units of the modification site according to the number of functional groups is preferably 4 or less, 3 or less, 2 or less, or 1 or less. When the total number of repeating units of the modification site is reduced, when the (meth)acryloyl equivalent is reduced, the crosslinking density increases and the cured product is not easily deformed, which can be considered to contribute to the stable hydrophilic performance of the obtained laminate.

Specific examples of the tri- or higher functional (meth)acrylate monomer include, but are not limited to, tris [2-((meth)acryloyloxy)ethyl] isocyanurate, trimethylolpropane tri(meth)acrylate, pentaerythritol tri(meth)acrylate, pentaerythritol tetra(meth)acrylate, pentaerythritol alkoxy tetra(meth)acrylate, dipentaerythritol hexa(meth)acrylate, ethoxylated trimethylolpropane tri(meth)acrylate, ethoxylated pentaerythritol tetra(meth)acrylate, tri- or higher functional urethane (meth)acrylate (e.g., trifunctional, tetrafunctional, hexafunctional, nine-functional, or 10 functional urethane (meth)acrylate), and tri- or higher functional epoxy (meth)acrylate.

The (meth)acrylic resin and the resin having a urethane bond may be prepared by using, for example, at least one selected from the group consisting of an oligomer of a tri- or higher functional (meth)acrylate monomer, a bifunctional (meth)acrylate monomer, and a monofunctional (meth)acrylate monomer in combination, in addition to the tri- or higher functional (meth)acrylate monomer.

Examples of the bifunctional (meth)acrylate monomer include 1,4-butanediol di(meth)acrylate, 1,6-hexanediol di(meth)acrylate, ethylene glycol di(meth)acrylate, cyclohexanedimethanol di(meth)acrylate, diethylene glycol di(meth)acrylate, dipropylene glycol di(meth)acrylate, polyethylene glycol di(meth)acrylate, polypropylene glycol (meth)acrylate, polytetramethylene glycol (meth)acrylate, tricyclodecanedimethanol di(meth)acrylate, and fluorene di(meth)acrylate. The bifunctional (meth)acrylate monomer can be used alone, or two or more thereof can be used in combination.

Examples of the monofunctional (meth)acrylate monomer include n-hexyl (meth)acrylate, n-heptyl (meth)acrylate, n-octyl (meth)acrylate, n-nonyl (meth)acrylate, n-decyl (meth)acrylate, n-undecyl (meth)acrylate, n-dodecyl (meth)acrylate, n-tridecyl (meth)acrylate, n-tetradecyl (meth)acrylate, n-pentadecyl (meth)acrylate, n-octadecyl (meth)acrylate, isoboronyl (meth)acrylate, and tetrahydrofurfuryl (meth)acrylate. The monofunctional (meth)acrylate monomer can be used alone, or two or more thereof can be used in combination.

The first layer of the present disclosure can be formed using a coating composition described later. Such a coating composition contains a binder precursor that finally becomes a binder of the first layer.

In the first layer of the present disclosure, from the viewpoint of the thermal stability and the like of the hydrophilic layer, the binder contains a cured product of a binder precursor containing approximately 30 mass % or greater of the tri- or higher functional (meth)acrylate monomer relative to a total amount of the binder. The content of the tri- or higher functional (meth)acrylate monomer in the binder precursor is preferably approximately 40 mass % or greater, approximately 50 mass % or greater, or approximately 70 mass % or greater, and more preferably 80 mass % or greater. In one embodiment, the content can be 100 mass %. In general, when the content of the tri- or higher functional monomer increases, the crosslinking density increases and a cured product that is not easily deformed, so that the hydrophilic performance of the obtained laminate tends to be stabilized. Here, the proportion of the tri- or higher functional (meth)acrylate monomer in the binder precursor and the cured product of the precursor can be evaluated using pyrolysis gas chromatography.

In the first layer of the present disclosure, the binder contains a cured product of a binder precursor containing approximately 30 mass % or greater of the tri- or higher functional (meth)acrylate monomer relative to the total amount of the binder. When the proportion of the tri- or higher functional (meth)acrylate monomer increases, the crosslinking density of the binder can be increased, so that the obtained cured product is less likely to be deformed. On the other hand, the first layer of the present disclosure contains inorganic nanoparticles in addition to the binder. Therefore, it is considered that the interface between the binder component and the inorganic nanoparticle surface layer affects the thermal stability of the first layer. In general, when the crosslinking density is improved, the elastic modulus of the cured product is improved, and the stress when the cured product is obtained is increased. As a result, deformation is likely to occur due to the internal stress generated by shrinkage during curing or the external stress generated by a heat treatment or the like. In general, as the amount of the tri- or higher functional (meth)acrylate monomer is large, the initial hydrophilicity of the hydrophilic layer tends to be increased, and the thermal stability also tends to be improved.

In the first layer of the present disclosure, the binder is prepared using a binder precursor containing a tri- or higher functional (meth)acrylate monomer in an amount of 30 mass % or more relative to the total amount of the binder precursor, and in addition, by using the inorganic nanoparticles having a reactive group (that is, a (meth)acryloyl group) on the inorganic nanoparticle surface, of which at least a part can be bonded to the binder, the binder and the inorganic nanoparticles are bonded, and the shrinkage and the like generated during curing can be suitably suppressed. As a result, it is considered that plastic deformation of the surface of the first layer can be reduced or prevented, and at the same time, plastic deformation of the second layer disposed in the first layer can be reduced or prevented. As described above, since the plastic deformation of the hydrophilic second layer disposed in the first layer can be reduced or suppressed, the thermal stability of the hydrophilic layer can be improved. In addition, a polyfunctional (meth)acrylate monomer such as a tri- or higher functional (meth)acrylate monomer often behaves as hydrophobic, and it is considered desirable to modify the inorganic nanoparticle surface with a reactive group ((meth)acryloyl group) having affinity with such a monomer from an optical viewpoint.

The first layer of the present disclosure includes inorganic nanoparticles having a (meth)acryloyl group. In the (meth)acryloyl group (reactive group), at least a part of such a group reacts with a functional group of a binder precursor component or a (meth)acrylate monomer constituting the binder component to be bonded to the binder in the first layer, and at least a part thereof is bonded and immobilized to the binder. Therefore, as described above, it is possible to contribute to the thermal stability of the hydrophilic layer. The reaction between the reactive group and the binder precursor component or the binder component is not particularly limited, and examples thereof include a thermal polymerization reaction, a photopolymerization reaction, a condensation reaction, and an addition reaction.

The introduction of the reactive group into the inorganic nanoparticles can be performed, for example, by modifying the inorganic nanoparticles with a surface treatment agent. In general, the surface treatment agent has a first end portion to be bonded (e.g., covalent bonding, ionic bonding, or bonding by strong physical adsorption) to the particle surface and a second end portion (reactive group) that can react with the binder component or the binder precursor component to be integrated with the binder. Examples of the surface treatment agent include alcohol, amine, carboxylic acid, sulfonic acid, phosphonic acid, silane, and titanate. The preferable type of the surface treatment agent is determined to some extent by the chemical nature of the inorganic nanoparticle surface. Silane is preferable for a silica particle and other silicon-based particles. Silane and carboxylic acid are preferable for the metal oxide. The surface modification can be performed either following or after mixing with the monomer. When the silane is used, the reaction of the silane with the inorganic nanoparticle surface preferably precedes the incorporation into the binder. The desired amount of the surface treatment agent depends on various factors such as a particle size, types of particles, a molecular weight of the surface treatment agent, and types of the surface treatment agent. In general, it is preferable that a substantially monolayer surface treatment agent is bonded to the particle surface. The required bonding procedure or reaction conditions will also depend on the surface treatment agent used. For example, when using silane, a surface treatment at a high temperature under acidic or basic conditions is preferable for approximately 1 hour to approximately 24 hours. In the surface treatment agent such as carboxylic acid, a high temperature or a long time is not usually required.

Examples of the surface treatment agent include, but are not limited to, isooctyltrimethoxy-silane, N-(3-triethoxysilylpropyl) methoxyethoxyethoxyethylcarbamate (PEG3TES), SILQUEST (trade name) A 1230, N-(3-triethoxysilylpropyl) methoxyethoxyethoxyethylcarbamate (PEG2TES), 3-(methacryloyloxy) propyltrimethoxysilane, 3-acryloxypropyltrimethoxysilane, 3-(methacryloyloxy) propyltriethoxysilane, 3-(methacryloyloxy) propylmethyldimethoxysilane, 3-(acryloyloxypropyl) methyldimethoxysilane. 3-(methacryloyloxy) propyldimethoxysilane, 3-(methacryloyloxy) propyldimethoxysilane, vinyldimethoxysilane, phenyltrimethoxysilane, n-octyltrimethoxysilane, dodecyltrimethoxysilane, octadecyltrimethoxysilane, propyltrimethoxysilane, hexyltrimethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane, vinyltriisopropenoxysilane, vinyltris(2-methoxyethoxy) silane, styrylethyltrimethoxysilane, mercaptopropyltrimethoxysilane, 3-mercaptopropylmethyldimethoxysilane. 3-mercaptopropyltrimethoxysilane, 3-glycidoxypropyltrimethoxysilane, 3-glycidoxypropylmethyldiethoxysilane, 3-glycidoxypropyltriethoxysilane, 2-(3,4-epoxycyclohexyl) ethyltrimethoxysilane, N-2-(aminoethyl)-3-aminopropylmethyldimethoxysilane, N-2-(aminoethyl)-3 aminopropyltrimethoxysilane, 3-aminopropyltrimethoxysilane, 3-aminopropyltriethoxysilane, 3-ureidopropyltrialkoxysilane, 3-isocyanatopropyltriethoxysilane, 3-trimethoxysilylpropylsuccinic anhydride, acrylic acid, methacrylic acid, oleic acid, stearic acid, dodecanoic acid, 2-[2-(2-methoxyethoxy) ethoxy] acetic acid (MEEAA), β-carboxyethylacetic acid. 2-(2-methoxyethoxy) acetic acid, methoxyphenylacetic acid, and mixtures of two or more thereof.

Since a (meth)acryloyl group is used as the reactive group of the inorganic nanoparticles, among the above-described surface treatment agents, 3-(methacryloyloxy) propyltrimethoxysilane, 3-(acryloxypropyl) trimethoxysilane, 3-(methacryloyloxy) propyltriethoxysilane, 3-(methacryloyloxy) propylmethyldimethoxysilane, 3-(acryloyloxypropyl) methyldimethoxysilane, 3-(methacryloyloxy) propyldimethylethoxysilane, 3-(methacryloyloxy) propyldimethylethoxysilane, acrylic acid, methacrylic acid, and mixtures thereof that can introduce a (meth) acryloyl group are preferable.

The particles constituting the inorganic nanoparticles are not limited to the following, and for example, at least one kind of particles selected from the group consisting of silica (SiO, SiO₂), alumina (Al₂O₃), zinc oxide (ZnO), zirconium oxide (ZrO₂), tin-doped indium oxide (ITO), and antimony-doped tin oxide (ATO) can be used. Among them, silica, alumina, and zirconium oxide are preferable, and silica is more preferable from the viewpoint of interlayer adhesion to the hydrophilic layer, scratch resistance, and the like.

The content of the inorganic nanoparticles can be, for example, more than approximately 50 mass %, approximately 55 mass % or greater, approximately 60 mass % or greater, approximately 65 mass % or greater, or approximately 70 mass % or greater, based on the total weight (dry coating amount) of the first layer. The upper limit value of the content of the inorganic nanoparticles is not particularly limited, but can be approximately 90 mass % or less, approximately 87 mass % or less, approximately 85 mass % or less, or approximately 83 mass % or less from the viewpoint of the thermal stability of the hydrophilic layer and the like. When the inorganic nanoparticles are blended in the first layer at such a ratio, the interlayer adhesion of the hydrophilic layer can be improved, and the hardness of the first layer can also be improved, so that the scratch resistance and the like of the hydrophilic layer disposed in the first layer can also be improved. Generally, when the content of the inorganic nanoparticles in the first layer is large, the crosslinking density is increased, so that the obtained laminate can contribute to stable hydrophilic performance, and the initial hydrophilicity of the hydrophilic layer tends to be excellent.

The average particle size of the inorganic nanoparticles can be measured by a transmission electron microscope (TEM) or the like using a technique commonly used in the present technical field. In measuring the average particle size of inorganic nanoparticles, a sol sample can be prepared for a TEM image by dropping the sol sample onto a 400-mesh copper TEM lattice having an ultrathin carbon substrate on the upper surface of the lace-like carbon of the mesh (available from Ted Pella Inc. (Redding, CA)). Some of the droplets can be removed by bringing the droplets together with filter paper into contact with the side or bottom of the grid. The remainder of the solvent of the sol can be removed by heating or allowing it to stand at room temperature. This enables the particles to remain on the ultra-thin carbon substrate and be imaged with minimal interference from the substrate. The TEM image can then be recorded at many locations throughout the entire grid. Sufficient number of images is recorded to enable particle sizes of 500 to 1000 particles to be measured. The average particle size of the inorganic nanoparticles can then be calculated based on the particle size measurement value for each sample. The TEM image can be obtained using, for example, a high-resolution transmission electron microscope (available from Hitachi High-Technologies Corporation under the trade designation “Hitachi H-9000”) operating at 300 KV (using an LaB, source). The image can be recorded using a camera (e.g., available from Gatan, Inc. (Pleasanton, CA) under the trade designation “GATAN ULTRASCAN CCD”: Model No. 895, 2 k×2 k chips). The image can be taken at a magnification of from 50000 fold and 100000 fold. For some samples, the image can be taken at a magnification of 300000 fold.

The average particle size of the inorganic nanoparticles can be approximately 1 nm or greater, approximately 5 nm or greater, approximately 10 nm or greater, approximately 15 nm or greater, or approximately 20 nm or greater, and can be approximately 500 nm or less, approximately 400 nm or less, approximately 300 nm or less, approximately 200 nm or less, or approximately 100 nm or less.

The inorganic nanoparticles may be formed of a small particle group and a large group of particles. In this case, the average particle size of the group of small particles can range from approximately 2 nm or greater, approximately 3 nm or greater, approximately 5 nm or greater, approximately 70 nm or greater, approximately 10 nm or greater, approximately 15 nm or greater, or approximately 20 nm or greater, and approximately 200 nm or less, approximately 150 nm or less, approximately 120 nm or less, approximately 100 nm or less, approximately 80 nm or less, approximately 60 nm or less, or approximately 40 nm or less. The average particle size of the large group of particles can range from approximately 60 nm or greater. approximately 65 nm or greater, approximately 70 nm or greater, or approximately 75 nm or greater, and approximately 400 nm or less, approximately 350 nm or less, approximately 300 nm or less, approximately 200 nm or less, approximately 150 nm or less, or approximately 100 nm or less.

Considering a high loading of inorganic nanoparticles in the first layer, it is preferable to use a mixture of inorganic nanoparticles having at least two different particle size distributions. The particle size distribution of the mixture of the inorganic nanoparticles exhibits a bimodal or multimodal peak that peaks the average particle size of the group of small particles and the average particle size of the group of large particles. For example, when two types of inorganic nanoparticles having different average particle sizes are included in the coating composition, the bimodal peak is measured in a graph of the particle size distribution. That is, from the number of peaks in the graph of the particle size distribution, it is possible to check how many kinds of inorganic nanoparticles having different average particle sizes are contained. Here, the particle size distribution of the coating composition can be measured by a laser diffraction/scattering method using a particle size distribution measuring apparatus (LS I3 320) available from Beckman Coulter, Inc.

In some embodiments, the ratio of the average particle size of the inorganic nanoparticles having an average particle size in the range of approximately 2 nm to approximately 200 nm to the average particle size of the inorganic nanoparticles having an average particle size in the range of approximately 60 nm to approximately 400 nm is in the range of 2:1 to 200:1, and in some embodiments, in the range of 2.5:1˜100:1, or 2.5:1 to 25:1. Examples of preferable average particle size combinations include combinations of 5 nm/190 nm, 5 nm/75 nm, 20 nm/190 nm, 5 nm/20 nm, 20 nm/75 nm, 75 nm/190 nm, or 5 nm/20 nm/190 nm. When such a mixture of the inorganic nanoparticles having different average particle sizes is used, the transparency of the first layer can be improved, and a large amount of inorganic nanoparticles can be filled in the first layer, so that performance such as hardness and scratch resistance can be improved. The use of a mixture of the inorganic nanoparticles having at least two different particle size distributions in the first layer can be indirectly identified from, for example, results of transparency (total light transmittance and haze value) and scratch resistance (Δ haze value) described later.

For example, performance such as transparency (e.g., total light transmittance and haze), scratch resistance, hardness, and thermal stability of the hydrophilic layer can be adjusted by adjusting the type, amount, and size of inorganic nanoparticles, and the ratio of each particle in the case of using inorganic nanoparticles having different average particle sizes.

The mass ratio (%) of the group of small particles to the group of large particles can be selected depending on the particle size to be used or the combination of particle sizes to be used. The preferable mass ratio can be selected according to the particle size to be used or the combination of particle sizes to be used, using the software available under the trade name “CALVOLD2”, and can also be selected, for example, on the basis of a simulation between the mass ratio and the filling rate of a group of small particles and a group of large particles for a combination of particle sizes (group of small particles/group of large particles) (“Verification of a Model for Estimating the Void Fraction in a Three-Component Randomly Packed Bed,” M. Suzuki and T. Oshima: Powder Technol., 43, 147-153 (1985)).

In some embodiments, the first layer may include, as other optional components, additives such as a filler other than the above-described inorganic nanoparticles, an ultraviolet absorber, a light stabilizer, a heat stabilizer, a dispersant, a plasticizer, a flow improver, a leveling agent, a pigment, and a dye. These additives can be used alone, or in combination of two or more types thereof. The individual amount and the total amounts of these additives can be determined within a range that does not impair the properties required for the first layer.

The use of fillers other than the inorganic nanoparticles (e.g., metal particles such as silver, copper, or iron, or organic particles) may lower the thermal stability of the hydrophilic layer. Therefore, the content of such fillers is preferably approximately 10 mass % or less, approximately 5 mass % or less, approximately 3 mass % or less, approximately 1 mass % or less, or approximately 0.5 mass % or less, based on the total weight of the first layer, or the fillers are more preferably not blended in the first layer.

The thickness of the first layer can be, for example, approximately 0.5 micrometers or greater, approximately 1 micrometers or greater, approximately 2 micrometers or greater, approximately 3 micrometers or greater, approximately 4 micrometers or greater, approximately 5 micrometers or greater, approximately 8 micrometers or greater, approximately 10 micrometers or greater, approximately 15 micrometers or greater, or approximately 20 micrometers or greater, and can be approximately 200 micrometers or less, approximately 150 micrometers or less, approximately 100 micrometers or less, approximately 80 micrometers or less, approximately 50 micrometers or less, approximately 30 micrometers or less, approximately 20 micrometers or less, approximately 15 micrometers or less, or approximately 10 micrometers or less. The thickness of the first layer can be appropriately selected from such a range based on the shrinkage at the time of curing and required performance (e.g., scratch resistance, optical characteristics, and the like) according to use. The thickness of the first layer is intended to be an average value of differences obtained by measuring the thickness of any at least three stacked configurations and the thickness of the substrate alone using a digital micrometer.

The coating composition of the present disclosure for preparing a first layer (may be referred to as a “first coating composition” or a “coating composition for a first layer”) can contain various materials that can be used in the first layer described above. The coating composition contains a binder precursor and inorganic nanoparticles having a reactive group ((meth)acryloyl group) capable of reacting at least a part with the binder precursor, in which the binder precursor contains 30 mass % or greater of a tri- or higher functional (meth)acrylate monomer relative to the total amount of the binder precursor.

The coating composition for a first layer is used so as to apply a hydrophilic layer to the first layer formed by such a composition.

The content of the binder precursor in the coating composition for a first layer can be, for example, approximately 10 parts by mass or greater, approximately 13 parts by mass or greater, approximately 15 parts by mass or more, or approximately 17 parts by mass or greater, and can be, for example, less than approximately 50 parts by mass, approximately 45 parts by mass or less, approximately 40 parts by mass or less, approximately 35 parts by mass or less, or approximately 30 parts by mass or less, based on 100 parts by mass of solid content of the coating composition, from the viewpoint of adhesion to the hydrophilic layer, shrinkage of the first layer during curing, and scratch resistance of the resulting laminate.

The content of the inorganic nanoparticles in the coating composition for a first layer can be more than approximately 50 parts by mass, approximately 55 parts by mass or greater, approximately 60 parts by mass or greater, and approximately 65 parts by mass or greater, or approximately 70 parts by mass, based on 100 parts by mass of solid content of such a coating composition. The upper limit value of the content of the inorganic nanoparticles is not particularly limited, but can be approximately 90 mass % or less, approximately 87 parts by mass or less, approximately 85 parts by mass or less, or approximately 83 parts by mass or less from the viewpoint of the thermal stability of the hydrophilic layer and the like.

The various additives of the optional components described above can be appropriately blended in the coating composition for a first layer in a range that does not impair the necessary characteristics of the first layer obtained by the coating composition for a first layer. In the coating composition for a first layer, a crosslinking agent and a curing agent can also be appropriately blended.

The curing of the monomer and the like of the coating composition for a first layer is not limited to the following but can be performed, for example, by thermal polymerization or photopolymerization. For the thermal polymerization, a thermal polymerization initiator is used. As the thermal polymerization initiator, for example, a known material such as a peroxide or an azo compound can be used. The thermal polymerization initiator can be used alone or in combination of two or more.

Photopolymerization can use ionizing radiation, such as, for example, an electron beam and UV light. In using an electron beam, a photopolymerization initiator is not necessary to be used, but in photopolymerization using UV light, a photopolymerization initiator is used. As the photopolymerization initiator, a known material can be used. Examples thereof include 1-[4-(2-hydroxyethoxyl)-phenyl]-2-hydroxy-methylpropanone, 2-hydroxy-1-{4-[4-(2-hydroxy-2-methyl-propionyl)-benzyl]-phenyl}-2-methyl-propane-1-one, oligo (2-hydroxy-2-methyl-1-[4-(1-methylvinyl) phenyl]propanone), 2-hydroxy-1-{4-[4-(2-hydroxy-2-methylpropionyl) phenoxy] phenyl}-2-methylpropanone, and 1-hydroxycyclohexyl phenyl ketone. The photopolymerization initiator can be used alone or in combination of two or more.

In order to improve workability, coatability, and the like, the coating composition for a first layer can optionally contain a solvent, for example, an organic solvent such as 1-methoxy-2-propanol.

The method of forming a first layer using the surface coating composition for a first layer is not particularly limited, and a known method can be employed. For example, the first layer can be formed by coating the substrate with the coating composition by knife coating, bar coating, blade coating, doctor coating, roll coating, cast coating, notch bar coater, curtain coating, spray coating, dip coating, gravure coating, or the like, drying the coating composition as necessary, and thermally curing or photocuring the coating composition.

When a second layer is directly disposed on the first layer, a surface treatment can be applied to the surface of the first layer in order to improve interlayer adhesion between the first layer and the second layer. Examples of such a surface treatments include a chemical treatment, a corona treatment (e.g., air or nitrogen corona), plasma, flame, or actinic radiation.

The laminate of the present disclosure has a hydrophilic second layer disposed on the first layer. From the viewpoint of thermal stability of the hydrophilic layer, the second layer is preferably disposed directly relative to the first layer.

The degree of hydrophilicity of the second layer is not particularly limited. For example, the water contact angle before the heat aging acceleration test of the second layer (simply “initial heat aging acceleration test”) can be approximately 50° or lower, approximately 40.0° or lower, approximately 30.0° or lower, approximately 20.0° or lower, or approximately 10.0° or lower. The lower limit of the initial water contact angle is not particularly limited, and can be, for example, approximately 1.0° or higher, approximately 3.0° or higher, or approximately 5.0° or higher.

In the laminate of the present disclosure, since the second layer is disposed relative to the first layer described above, the thermal stability of the hydrophilic layer (second layer) can be improved. Such stability can be evaluated by the water contact angle after the heat aging acceleration test at 90° C. for 1 week, and the initial water contact angle. In some embodiments, the laminate of the present disclosure satisfies Formula 1 below and/or Formula 2 below:

(Water contact angle after heat aging acceleration test at 90° C. for 1 week)≤30.0° Formula 1

(Water contact angle after heat aging acceleration test at 90° C. for 1 week−initial water contact angle)≤15.0° Formula 2

In some embodiments, the laminate of the present disclosure satisfies a value of “water contact angle after heat aging acceleration test at 90° C. for 1 week” of approximately 27.0° or lower, approximately 25.0° or lower, or approximately 23.0° or lower relative to the above Formula 1. The lower limit of the above value is not particularly limited, and can be, for example, approximately 1.0° or higher, approximately 2.0° or higher, approximately 3.0° or higher, approximately 4.0° or higher, or approximately 5.0° or higher.

In some embodiments, the laminate of the present disclosure satisfies a value of “water contact angle after heat aging acceleration test at 90° C. for 1 week−initial water contact angle” of approximately 14.0° or lower, approximately 13.5° or lower, or approximately 13.0° or lower relative to the above Formula 2. The lower limit of the above value is not particularly limited, and can be, for example, approximately 0.1° or higher, approximately 0.2° or higher, approximately 0.3° or higher, or approximately 0.4° or higher.

The material of the hydrophilic second layer is not particularly limited, but the second layer preferably contains zwitterionic silane from the viewpoint of stable interface formation of the hydrophilic layer. Such silane preferably contains at least one phosphate group (PO₄⁻³) or sulfonate group (SO₃⁻).

Examples of zwitterionic sulfonate functional compounds include those disclosed in U.S. Pat. No. 5,936,703 (Miyazaki et al.) and WO 2007/146680 and WO 2009/119690.

In some embodiments, as the zwitterionic sulfonate functional compound used in the coating composition for preparing the second layer of the present disclosure (may be referred to as a “second coating composition” or a “coating composition for a second layer”), an amphoteric ionic sulfonate-organic silanol compound represented by Formula (I) below is used:

(R¹O)ₚ—Si(R²)_{q}W—N⁺(R³)(R⁴)—(CH₂)ₘ—SO₃⁻ Formula (I)
where in Formula (I),
R¹ is, each independently, a hydrogen, a methyl group, or an ethyl group;
R² is, each independently, a methyl group or an ethyl group;
R³ and R⁴ are, each independently, a saturated or unsaturated, linear, molecular, or cyclic organic group, which may be optionally bonded with an atom of a group W to form a ring;
W is an organic linking group;
p and m are integers from 1 to 3;
q is 0 or 1; and
p+q is 3.

The organic linking group W of Formula (I) may preferably be selected from saturated or unsaturated, linear, branched, or cyclic organic groups. The linking group W is preferably an alkylene group and may contain heteroatoms such as a carbonyl group, a urethane group, a urea group, oxygen, nitrogen, and sulfur, as well as combinations thereof. Examples of the suitable linking group W include an alkylene group, a cycloalkylene group, an alkyl-substituted cycloalkylene group, a hydroxy-substituted alkylene group, a hydroxy-substituted monooxaalkylene group, a divalent hydrocarbon group having a monooxa skeleton substitution, a divalent hydrocarbon group having a monothia skeleton substitution, a divalent hydrocarbon group having a monooxo-thia skeleton substitution, a divalent hydrocarbon group having a dioxo-thia skeleton substitution, an arylene group, an arylalkylene group, an alkylarylene group, and a substituted alkylarylene group.

Suitable examples of the zwitterionic silane of Formula (I) are disclosed in U.S. Pat. No. 5,936,703 (Miyazaki et al.) and WO 2007/146680 and WO 2009/119690, and include the following zwitterionic functional groups (—W—N⁺(R³)(R⁴)—(CH₂)ₘ—SO₃⁻):

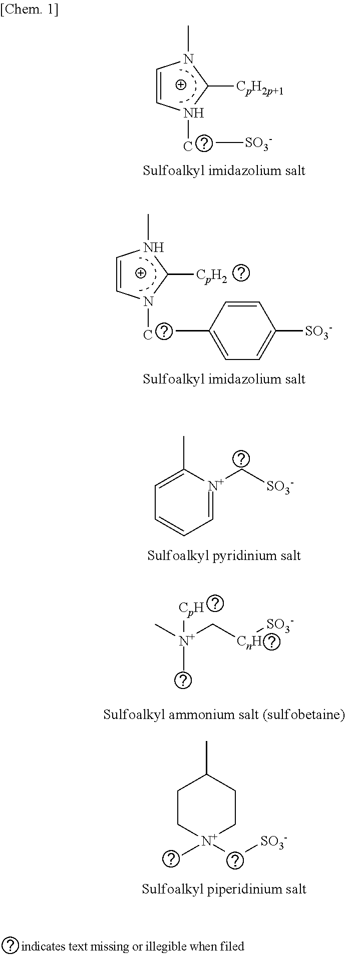

In some embodiments, as the zwitterionic sulfonate functional compound used in the coating composition for a second layer, a sulfonate-organic silanol compound represented by Formula (II) below is used:

(R¹O)ₚ—Si(R²)_{q}—CH₂CH₂CH₂—N⁺(CH₃)₂—(CH₂){12>m-SO₃⁻ Formula (II)
where in Formula (II),
R¹ is, each independently, a hydrogen, a methyl group, or an ethyl group;
R² is, each independently, a methyl group or an ethyl group;
p and m are integers from 1 to 3;
q is 0 or 1; and
p+q is 3.

Suitable examples of the zwitterionic silane of Formula (II) are disclosed in U.S. Pat. No. 5,936,703 (Miyazaki et al.) and include, for example:

(CH₃O)₃Si—CH₂CH₂CH₂—N⁺(CH₃)₂—CH₂CH₂CH₂—SO₃⁻; and

(CH₃CH₂O)₂Si(CH₃)—CH₂CH₂CH₂—N⁺(CH₃)₂—CH₂CH₂CH₂—SO₃⁻.

Other examples of the suitable zwitterionic silane include:

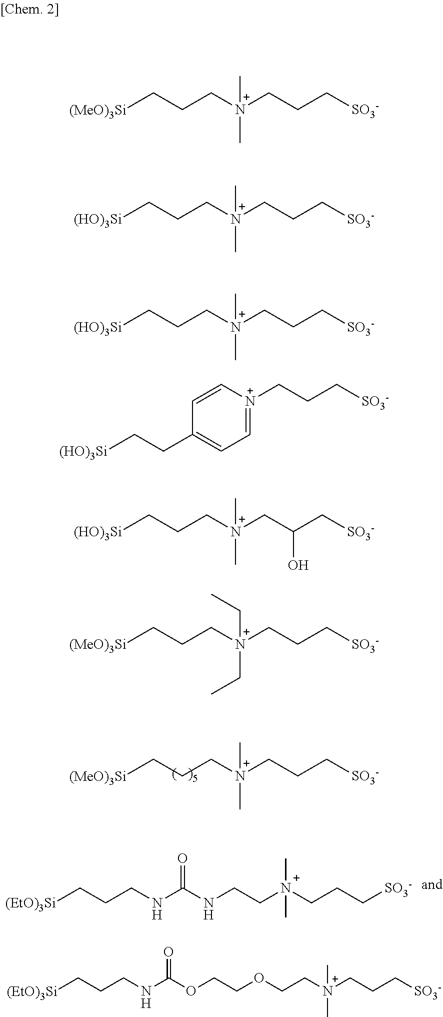

In the coating composition for a second layer, typically, the zwitterionic silane can be blended in an amount of approximately 0.01 mass % or greater, approximately 0.05 mass % or greater, approximately 0.10 mass % or greater, approximately 0.15 mass % or greater, or approximately 0.20 mass % or greater, approximately 20 mass % or less, approximately 15 mass % or less, approximately 10 mass % or less, approximately 5 mass % or less, or approximately 1 mass % or less based on the total weight of the coating composition. In order to obtain a monolayer second layer of the above-described thickness, a relatively diluted coating composition is generally used. Altematively, a relatively concentrated coating composition can be used to form the second layer, followed by partial rinsing of the second layer.

The coating composition for a second layer preferably contains alcohol, water, or a hydroalcoholic solution (that is, alcohol and/or water). Typically, lower alcohols (e.g., a C₁ to C₈ alcohol, more typically a C₁ to C₄ alcohol.) such as methanol, ethanol, propanol, 2-propanol can be used as such alcohols. Preferably, the coating composition for a second layer is an aqueous solution. As used herein, the term “aqueous solution” means a solution containing water. Such solutions may use water as the only solvent or may combine water and organic solvents, such as alcohol and acetone. In order to improve freeze-thaw stability, an organic solvent may be included in the coating composition for a second layer. Typically, the organic solvent can be blended in an amount ranging from up to approximately 50 mass % of the composition, preferably from approximately 5 mass % to approximately 50 mass % of the composition.

The coating composition for a second layer may be acidic, basic, or neutral. Durability performance of the second layer formed by such a composition may be affected by pH. For example, the coating composition containing the sulfonate-functional zwitterionic silane is preferably neutral.

The coating composition for a second layer may be provided at various viscosities. Thus, for example, the viscosity can vary from low water-like to high paste-like. Alternatively, the coating composition for a second layer may be provided in a gel form.

The coating composition for a second layer may contain various other components. As such a component, for example, known surfactants, such as cationic, anionic, or nonionic surfactants can be used. A detergent and a wetting agent can also be used.

In some embodiments, the coating composition for a second layer further contains an inorganic binder, such as a coupling agent, which may provide improved durability. Examples of such a coupling agent include tetraalkoxysilane (e.g., tetraethyl orthosilicate (TEOS)), an oligomer thereof, for example, alkyl polysilicate (e.g., poly (diethoxysiloxane)), lithium silicate, sodium silicate, potassium silicate, silica (e.g., silica particles), or a combination thereof. In some embodiments, the amount of such coupling agent contained in the coating composition is supposed to be limited to prevent the second layer from deteriorating in hydrophilic performance or optical performance, or the like. The optimum amount of the coupling agent is experimentally determined and depends on the nature, molecular weight, and refractive index of the coupling agent. The coupling agent, when present, is typically added to the composition at a concentration of from approximately 0.1 to approximately 20 mass % of the coating composition, more preferably from about 1 to approximately 15 mass % of the coating composition.

The method for forming the second layer using the coating composition for a second layer is not particularly limited, and examples thereof include knife coating, bar coating, blade coating, doctor coating, roll coating, notch bar coater, cast coating, curtain coating, spray coating, dip coating, gravure coating, and air knife coating. Preferable methods thereof include bar coating and roll coating or air knife coating to adjust the thickness.

After disposing the coating composition for a second layer on the first layer, it is typically preferable to dry the coating composition for a second layer at a temperature of approximately 20° C. to approximately 150° C. using an oven or the like. At this time, the inert gas may be circulated. The temperature may be further increased to accelerate the drying process; however, in this case, care must be taken to avoid damage to the substrate.

The thickness of the second layer is not particularly limited as long as optical characteristics are not impaired, and is preferably approximately 10 micrometers or less, approximately 7 micrometers or less, approximately 5 micrometers or less, approximately 3 micrometers or less, or approximately 1 micrometer or less in many cases. The lower limit value of the thickness of the second layer is not particularly limited, and can be, for example, approximately 100 angstroms or more, approximately 150 angstroms or more, or approximately 200 angstroms or more. Here, when the thickness of the second layer is approximately 100 angstroms or more, the thickness of the second layer can be measured using an Optical NanoGauge film thickness meter available from Hamamatsu Photonics K.K. using a spectral interference method. When the film thickness is less than about 100 angstroms, measurement can be performed by a measurement method using spectroscopic ellipsometry using polarized light.

As the substrate constituting the laminate of the present disclosure, for example, an organic substrate containing at least one selected from the group consisting of a polyvinyl chloride resin, a polyurethane resin, a polyolefin resin (e.g., polyethylene resin and polypropylene resin), a polyester resin (e.g., polyethylene terephthalate resin), a vinyl chloride-vinyl acetate resin, a polycarbonate resin, a (meth)acrylic resin, a cycloolefin resin, a cellulose resin, a polyethylene naphthalate resin, a polystyrene resin, an acrylonitrile styrene resin, cellulose diacetate, cellulose triacetate, an acrylonitrile butadiene styrene resin, ethylene vinyl acetate, a cyclohexyl ethylene-ethylene-(1-butene) copolymer ((Taiwan) available from USI, ViviOn (trade name)), and a fluororesin can be used. As the substrate, an inorganic substrate such as glass can be used.

The shape or configuration of the substrate is not particularly limited and may be, for example, a film shape, a plate shape, a curved surface shape, an odd shape, or a three-dimensional shape, or may be a single-layer configuration, a laminate configuration, or a composite configuration, such as those formed of a combination of a plurality of substrates having different shapes.

The substrate may be colorless. The substrate may be translucent or transparent, but is desirably transparent. The substrate may have a substantially smooth surface, may have a structured surface that can be formed by surface processing such as embossing, or may have been processed into a hole, a channel, or the like.

A surface treatment may be applied to the surface of the substrate. Examples of the surface treatment include an easy adhesion treatment (e.g., primer treatment), a chemical treatment (e.g., chemical etching treatment), a corona treatment (e.g., air or nitrogen corona), a plasma treatment, a flame treatment, and an actinic ray treatment.

The thickness of the substrate can be approximately 12 micrometer or greater, approximately 25 micrometer or greater, approximately 50 micrometer or greater, or approximately 80 micrometer or greater, and can be approximately 5 mm or less, approximately 1 mm or less, and approximately 0.5 mm or less. In one embodiment, the thickness of the substrate can be approximately 100 micrometers.

In some embodiments, a substrate is capable of being elongated is used as the substrate. The tensile elongation ratio of the stretchable substrate can be approximately 10% or greater, approximately 20% or greater, or approximately 30% or greater, and can be approximately 400% or less, approximately 350% or less, or approximately 300% or less. The tensile elongation rate of the substrate capable of being elongated is a value calculated as [chuck spacing at break (mm)−chuck spacing before elongation (mm) (=100 mm)]/chuck spacing before elongation (mm) (=100 mm)×100 (%), when a sample having a width of 25 mm and a length of 150 mm is prepared and the sample is elongated at a temperature of 20° C., a tensile speed of 300 mm/min, and a chuck spacing of 100 mm using a tensile tester until the sample is broken.

In some embodiments, in the laminate of this embodiment, additional layers such as a colored layer, a decorative layer, a bright layer, a bonding layer (primer layer), and an adhesive layer may be applied between the first layer and the substrate, or on the substrate surface on the side opposite to the second layer of the substrate. These additional layers can be used alone or in combination of two or more types thereof, and can be applied to the entire surface or part of the laminate. The thicknesses of the substrate and the additional layer can be determined in the same manner as in the first layer.

A generally used adhesive such as a solvent-type, emulsion-type, pressure-sensitive type, heat-sensitive type, or heat-curable or radiation-curable type (e.g., ultraviolet-curable type) adhesive, including acrylics, polyolefins, polyurethanes, polyesters, rubbers, or a silicone can be used as the adhesive layer.

The thickness of the adhesive layer is not limited to the following and, for example, 5 micrometers or more, approximately 10 micrometers or more, or approximately 20 micrometers or more, and can be approximately 100 micrometers or less, approximately 80 micrometers or less, or approximately 50 micrometers or less.

A release liner may be imparted to a surface of the adhesive layer. Examples of the release liner include paper; a plastic material such as polyethylene, polypropylene, polyester, and cellulose acetate; and paper coated with such a plastic material. These liners may have surfaces release-treated with silicone or the like. The thickness of the release liner, generally, can be approximately 5 micrometers or greater. approximately 15 micrometers or greater, or approximately 25 micrometers or greater, and can be approximately 500 micrometers or less, approximately 300 micrometers or less, or approximately 250 micrometers or less.

The laminate of the present embodiments may be, for example, a sheet-like article, a rolled body winded in a roll shape or an article with a three-dimensional shape.

In some embodiments, the laminate of the present disclosure has transparency. The transparency may be evaluated by the total light transmittance (initial total light transmittance) described above, or may be evaluated by a haze value (initial haze value). The laminate of the present disclosure, particularly a laminate using a transparent substrate can have a haze value of, for example, approximately 10% or less, approximately 7.0% or less, approximately 5.0% or less, approximately 3.0% or less, or approximately 1.0% or less. The lower limit of the haze value is not particularly limited, and can be, for example, approximately 0.10%, approximately 0.30% or greater, or more or approximately 0.50% or greater.

In some embodiments, the laminate of the present disclosure has scratch resistance. The scratch resistance can be evaluated by a difference in the haze value (Δ haze value) before and after a steel wool abrasion resistance test described later. The Δ haze value of the laminate can be −0.20% to 0.20%, −0.15% to 0.15%, or −0.10% to 0.10%.

The article including the laminate of the present disclosure can be used in various applications. Such applications are not particularly limited but include, for example, various components used in: medical devices (e.g., microchannel chips, measuring components such as PCR, catheters, guide wires, protective covers for various medical devices); protective equipment (e.g., protective equipment that protects eyes, mouth, and the like to protect healthcare workers or patients from splashing blood, body fluids, other fluids, and droplet infections); windows, mirrors, bodies, or light covers of vehicles (e.g., cars, ships, trains, and aircrafts); window glasses, sachets, doors, door knobs, or exterior materials of buildings; faucet handles; home electric appliances (e.g., air conditioners, electric fans, vacuum cleaners, washing machines, and refrigerators); lenses or bodies of cameras; watches; optical displays (e.g., cathode-ray tubes (CRT), liquid crystal (LCD) displays, and light-emitting diode (LED) displays); mobile terminals (e.g., personal digital assistants (PDA), mobile phones, and smart phones); devices, such as keyboards, touch screens, and removable computer screens; traffic signals; mirrors, glasses, or goggles; cards; tableware; furniture (e.g., tables, chairs, and desks); packaging materials; signs; measuring instruments or observation instruments; solar panels; and wind power generation.

For example, when the medical device is in direct contact with a biological material such as biological tissue and body fluid, an initial interaction between the device and the biological material occurs at a surface of the device. For example, the tissue of protein changes in interaction with the surface of the device, which may lead to undesirable adverse effects downstream. For the purpose of reducing or preventing such interaction, hydrophilic performance may be imparted to the medical device. Alternatively, a microfluidic chip used in blood collection, such as diabetes, generally utilizes capillary action when collecting blood through a microfluidic channel in the chip without using a physical suction device such as a pump. In order to more easily develop this capillary phenomenon, it is desirable that hydrophilicity is imparted to the microchannel chip. Therefore, an article including the laminate of the present disclosure capable of stably imparting hydrophilic performance can be advantageously used as a medical device, and among them, can be more advantageously used as a microchannel chip.

Examples of the flow path forming method for manufacturing the microflow path chip generally include a method in which a transparent film sheet; a hydrophilic film sheet which is a laminate of the present disclosure, and a pressure sensitive adhesive sheet including a substrate or a pressure sensitive adhesive sheet not including a substrate are punched into a predetermined shape, and the punched sheets are stacked and bonded to each other to produce a flow path having a fine three-dimensional shape.

### EXAMPLES

Specific embodiments of the present disclosure will be exemplified in the following examples, but the present invention is not limited to these embodiments. All parts and percentages are based on mass unless otherwise specified. The numerical value essentially includes errors due to a measurement principle and a measurement device. The numerical value is indicated by a significant number that has undergone a normal rounding treatment.

Various materials used in examples and comparative examples are shown in Table 1.

TABLE 1

| | Trade name, | | |
|---|---|---|---|
| | model No., or | | |
| Type | abbreviation | Description | Source of supply |
| Inorganic | Nanoparticle | Silica nanoparticle having a methacryloyl | 3M Company (US) |
| nanoparticles | dispersion 1 | group dispersed in 1-methoxy-2-propanol, | |
| | | average particle diameter: 75 nm, solid | |
| | | content: 38.8% | |
| | Nanoparticle | Silica nanoparticle having a methacryloyl | 3M Company (US) |
| | dispersion 2 | group dispersed in 1-methoxy-2-propanol, | |
| | | average particle diameter: 20 nm, solid | |
| | | content: 45.8% | |
| | Nanoparticle | Silica nanoparticle having a methacryloyl | 3M Company (US) |
| | dispersion 3 | group dispersed in 1-methoxy-2-propanol, | |
| | | average particle diameter: 5 nm, solid | |
| | | content: 32.0% | |
| | Nanoparticle | Colloidal silica nanoparticle dispersed in | NALCO Co. Ltd. |
| | dispersion 4 | water, average particle diameter: 75 nm, | (USA) |
| | (NALCO | solid content: 41.1% | |
| | (trade name) | | |
| | 2329K) | | |
| | Nanoparticle | Colloidal silica nanoparticle dispersed in | NALCO Co. Ltd. |
| | dispersion 5 | water, average particle diameter: 5 nm, | (USA) |
| | (NALCO | solid content: 15.9% | |
| | (trade name) | | |
| | 2326) | | |
| Binder precursor | Monomer 1 | Tris[2-(acryloyloxy) ethyl] isocyanurate, Mw | Sartomer (USA) |
| | (SR368 NS) | 423, number of functional groups 3, acryloyl | |
| | | equivalent 141, solid content 100% | |
| | Monomer 2 | Pentaerythritol triacrylate, | Sartomer (USA) |
| | (SR444 D NS) | Mw: 298, number of functional groups: 3, | |
| | | acryloyl equivalent: 99, solid content: 100% | |
| | Monomer 3 | Pentaerythritol tetraacrylate, | Sartomer (USA) |
| | (SR295 NS) | Mw: 352, number of functional groups: 4, | |
| | | acryloyl equivalent: 88, solid content: 100% | |
| | Monomer 4 | Dipentaerythritol hexaacrylate, | Daicel-Allnex Ltd. |
| | (DPHA) | Mw: 524, number of functional groups: 6, | (Chuo-ku, Tokyo, |
| | | acryloyl equivalent: 87, solid content: 100% | Japan) |
| | Monomer 5 | Trimethylolpropane triacrylate, | Sartomer (USA) |
| | (SR351 NS) | Mw: 296, number of functional groups: 3, | |
| | | acryloyl equivalent: 99, solid content: 100% | |
| | Monomer 6 | Pentaerythritol | Daicel-Allnex Ltd. |
| | (EBECRYL | alkoxy tetraacrylate, | (Chuo-ku, Tokyo, |
| | (trade name) | Mw: 571, number of functional groups: 4, | Japan) |
| | 40) | acryloyl equivalent: 143, solid content: 100% | |
| | Monomer 7 | Trifunctional urethane acrylate, | Daicel-Allnex Ltd. |
| | (EBECRYL | Mw: 2000, number of functional groups: 3, | (Chuo-ku, Tokyo, |
| | (trade name) | acryloyl equivalent: 667, solid content: 100% | Japan) |
| | 8701) | | |
| | Monomer 8 | Ethoxylated (9) trimethylolpropane | Sartomer (USA) |
| | (SR502 NS) | triacrylate, | |
| | | Mw: 692, number of functional groups: 3, | |
| | | acryloyl equivalent: 231, solid content: 100% | |
| | Monomer 9 | Ethoxylated (15) trimethylolpropane | Sartomer (USA) |
| | (SR9035) | triacrylate, Mw 956, number of functional | |
| | | groups 3, acryloyl equivalent 319, solid | |
| | | content 100% | |
| | Monomer 10 | Ethoxylated (35) pentaerythritol tetraacrylate, | Shin-Nakamura |
| | (ATM-35E) | Mw1892, Mw1892, number of functional | Chemical Co., Ltd. |
| | | groups 4, acryloyl equivalent 473, solid | (Wakayama-shi, |
| | | content 100% | Wakayama, Japan) |
| | Monomer 11 | PEG 600 diacrylate, | Daicel-Allnex Ltd. |
| | (EBECRYL | Mw: 654, number of functional groups: 2, | (Chuo-ku, Tokyo, |
| | (trade name) | acryloyl equivalent: 327, solid content: 100% | Japan) |
| | 11) | | |
| | Monomer 12 | 1,6-hexanediol diacrylate, | Sartomer (USA) |
| | (SR238 NS) | Mw: 226, number of functional groups: 2, | |
| | | acryloyl equivalent: 113, solid content: 100% | |
| Photopolymerization | Initiator 1 | Oligo (2-hydroxy-2-methyl-1-[4-(1- | IGM Resins B.V. |
| initiator | ESACURE | methylvinyl) phenyl] propanone) | (USA) |
| | (trade name) | | |
| | ONE) | | |
| | Initiator 2 | 1-[4-(2-hydroxyethoxyl)-phenyl]-2-hydroxy- | IGM Resins B.V. |
| | (Omnirad | methylpropanone | (USA) |
| | (trade name) | | |
| | 2959) | | |
| Solvent | MIPA | 1-methoxy-2-propanol | Fujifilm Wako |
| | | | Pure Chemical |
| | | | Corporation |
| | | | (Osaka-shi, Osaka, |
| | | | Japan) |
| | Water | Distilled water | 3M Japan Limited |
| | | | (Shinagawa-ku, |
| | | | Tokyo, Japan) |
| | ETOH | Ethanol | Fujifilm Wako |
| | | | Pure Chemical |
| | | | Corporation |
| | | | (Osaka-shi, Osaka, |
| | | | Japan) |
| | IPA | 2-Propanol | Fujifilm Wako |
| | | | Pure Chemical |
| | | | Corporation |
| | | | (Osaka-shi, Osaka, |
| | | | Japan) |
| Surface modifier | Silane coupling | SAC (acryloyltrimethoxysilane) | 3M Company (US) |
| | agent | | |
| Hydrophilic surface | Silane coupling | Zwitterionic silane-containing liquid | 3M Company (US) |
| modifier | agent | | |
| Inorganic binder | LS-75 | Lithium silicate, solid content 21% | Nissan Chemical |
| | | | Corporation |
| | | | (Chuo-ku, Tokyo, |
| | | | Japan) |
| Hydrophilic surface | Rhodacal | Surfactant, sodium dodecylbenzenesulfonate | Solvay S.A. |
| modifier | (trade name) | solid content 100% | (Belgium) |
| | Ds10 | | |
| Additive | Dynol (trade | Acetylene alcohol | Evonik AG |
| | name) 604 | | (Germany) |
| Substrate | COSMOSHINE | Transparent PET film, thickness 100 μm | Toyobo Co., Ltd. |
| | (trade name) | | (Osaka-shi, Osaka, |
| | A4360 | | Japan) |

### Example 1

### Preparation of Nanoparticle Dispersion

Nanoparticle dispersions 1 and 2 were prepared by methods of Comparative example modified silica sol (“Modified Sol 1”) and (“Modified Sol 2”) disclosed in WO 2018/185590 (Naota).

### Preparation of Coating Liquid for First Layer

A monomer 1, an initiator 1 and MIPA were mixed in a glass container at a ratio shown in Table 2, and then the nanoparticle dispersions 1 and 2 were further added. After mixing gently, a milky white translucent coating liquid for a first layer was obtained. Here, since the monomer 1 was in a solid state at room temperature, the monomer 1 was dissolved in an oven at about 75° C. and then added to a glass container.

### Preparation of Zwitterionic Silane-Containing Liquid

A zwitterionic silane-containing liquid containing zwitterionic silane of the following chemical structural formula was prepared by the method described in Preparative Example 3 of WO 2011/084661 (Naiyong et al.):

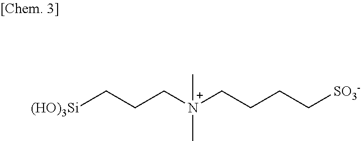

### Preparation of Coating Liquid for Second Layer

To a glass container, 54.62 parts by mass of water and 32.96 parts by mass of IPA were added. And then, 10.02 parts by mass of the zwitterionic silane-containing liquid, 0.94 parts by mass of the LS-75 aqueous solution adjusted to 5% solid content, 0.48 parts by mass of the Rhodacal (trade name) Ds 10 aqueous solution adjusted to 5% solid content, and 0.99 parts by mass of Dynol (trade name) 604 were added to the glass container to prepare a coating liquid for a second layer. The solid content of this coating liquid was 0.17%.

### Preparation of Laminate

The coating liquid for the first layer was applied to one surface of a transparent PET film substrate (COSMOSHINE (trade name) A4360) with a #7 wire bar, and then dried in an oven at 60° C. for 5 minutes. The film to which the first layer was applied was treated through an ultraviolet irradiator (H-valve (DRS model) available from Heraeus) four times under an (air) atmosphere to cure the first layer. At this time, the first layer was irradiated with UV light (UV-A) in conditions of an illuminance of 840 mW/cm² and an integrated light quantity of 650 mJ/cm². In this way, a first layer having a thickness of approximately 3 micrometers was prepared.

Subsequently, the first layer was subjected to a surface treatment using a corona treatment apparatus (available from Kasuga electric works Ltd., effective width: 250 mm) under the conditions of a coating speed of 6 m/min and an input power of 0.12 kW.

The coating liquid for a second layer was applied to the surface-treated first layer with the #3 wire bar, and then dried in an oven at 60° C. for 5 minutes and in an oven at 100° C. for 5 minutes to obtain a laminate having a hydrophilic second layer with a thickness from approximately 0.01 to 0.02 micrometers.

### Examples 2 to 31

Laminates of Examples 2 to 31 were produced in the same manner as in Example 1, except that the coating liquid for a first layer was changed to a material shown in Tables 2 and 3. Here, the nanoparticle dispersion 3 used in Example 6 was prepared by the method of Modified Silica Sol (Modified Sol A) disclosed in WO 2020/136535 A (Ito et al.). The monomers 7 used in Examples 18 to 22 were in a solid state at room temperature as was the monomer 1, and thus were dissolved in an oven at about 75° C. before being added to a glass container.

### Comparative Examples 1 to 5

### Preparation of SAC

The SAC of the silane coupling agent as a surface modifier was prepared by the method described in Preparative Example 7 of US 2015/0,203,708 A (Klun et al.).

Laminates of Comparative Examples 1 to 5 were produced in the same manner as in Example 1, except that the coating liquid for a first layer was changed to a material shown in Table 4. Here, the first layers in Comparative Examples 4 and 5 were produced using a #10 wire bar.

The following evaluations were carried out for each sample of Examples 1 to 31 and Comparative Examples 1 to 5, and the results are indicated in Tables 2 to 4.

### Water Contact Angle: Hydrophilicity

Using a contact angle meter (obtained from Kyowa Interface Science Co., Ltd. under the trade name of “DROPMASTER FACE”), the initial water contact angle of the surface of the second layer and the water contact angle after a heat aging acceleration test at 90° C. for 1 week were measured under the following measurement conditions. The values of the water contact angle (CA) in the table are average values measured 5 times, and the A CA value is a value obtained by subtracting the initial water contact angle from the water contact angle after the heat aging acceleration test at 90° C. for 1 week:

### Measurement Conditions

Test Methods: Sessile Drop method
Water drop amount: 2 microliters
Delay time: 1,000 ms
Measurement temperature: room temperature

### Optical Properties

The optical characteristics (haze and total light transmittance) of the laminate before and after the steel wool abrasion resistance test shown below were measured in accordance with in accordance with JIS K 7136 (2000) and JIS K 7361-1 (1997) using NDH 2000 (available from Nippon Denshoku Industries Co., Ltd.). Each value of the haze and the total light transmittance in the table is an average value measured three times, and the Δ haze value is a value obtained by subtracting the initial haze value from the haze value after the abrasion test:

### Steel Wool Abrasion Resistance Test

The surface of the second layer of the laminate 10 times (cycle) with 27 mm square #0000 is poli shed by using a steel wool abrasion resistance tester (rubbing tester IMC-157C, available from Imoto mac hinery Co., LTD) under the conditions of steel wool, 350 g load, 85 mm stroke, at a speed of 60 cycles/minute.

TABLE 2

| | | | Ex. | Ex. | Ex. | Ex. | Ex. | Ex. | Ex. | Ex. |
|---|---|---|---|---|---|---|---|---|---|---|
| | | | 1 | 2 | 3 | 4 | 5 | 6 | 7 | 8 |
| First | Inorganic | Nanoparticle dispersion 1 | 49.7 | 49 7 | 49 7 | 49.7 | 49.7 | 66.7 | 36.4 | 49.7 |
| layer | nanoparticles | Nanoparticle dispersion 2 | 22.7 | 22.7 | 22.7 | 22.7 | 22.7 | — | 16.6 | 22.7 |
| | | Nanoparticle dispersion 3 | — | — | — | — | — | 24.1 | — | — |
| | | Nanoparticle dispersion 4 | — | — | — | — | — | — | — | — |
| | | (no reactive group) | | | | | | | | |
| | | Nanoparticle dispersion 5 | — | — | — | — | — | — | — | — |
| | | (no reactive group) | | | | | | | | |
| | Binder | Monomer 1 (trifunctional) | 9.9 | 7.9 | 4.9 | 4.0 | 3.0 | 5.9 | 17.8 | — |
| | precursor | Monomer 2 (trifunctional) | — | — | — | — | — | — | — | 7.9 |
| | | Monomer 3 (tetrafunctional) | — | — | — | — | — | — | — | — |
| | | Monomer 4 (hexafunctional) | — | — | — | — | — | — | — | — |
| | | Monomer 5 (trifunctional) | — | — | — | — | — | — | — | — |
| | | Monomer 6 (tetrafunctional) | — | — | — | — | — | — | — | — |
| | | Monomer 7 (trifunctional) | — | — | — | — | — | — | — | — |
| | | Monomer 8 (trifunctional) | — | — | — | — | — | — | — | — |
| | | Monomer 9 (trifunctional) | — | — | — | — | — | — | — | — |
| | | Monomer 10 (tetrafunctional) | — | — | — | — | — | — | — | — |
| | | Monomer 11 (bifunctional) | — | — | — | — | — | — | — | — |
| | | Monomer 12 (bifunctional) | | 2.0 | 4.9 | 5.9 | 6.9 | — | — | 2.0 |
| | Photopolymerization | Initiator 1 | 1.2 | 1.2 | 1.2 | 1.2 | 1.2 | 1.2 | 1.2 | 1.2 |
| | initiator | Initiator 2 | — | — | — | — | — | — | — | — |
| | Surface modifier | SAC | — | — | — | — | — | — | — | — |
| | Solvent | MIPA | 16.6 | 16.6 | 16.6 | 16.6 | 16.6 | 2.1 | 28.0 | 16.6 |
| | | Water | — | — | — | — | — | — | — | — |
| | | ETOH | — | — | — | — | — | — | — | — |

| | | | | | | | | | |
|---|---|---|---|---|---|---|---|---|---|
| | Total | 100 | 100 | 100 | 100 | 100 | 100 | 100 | 100 |
| | Film thickness of first layer (μm) | 3.1 | 2.9 | 3.3 | 3.1 | 3.0 | 2.9 | 3 | 3.5 |
| | Content of inorganic nanoparticles | 73 | 73 | 73 | 73 | 73 | 83 | 53 | 73 |
| | in first layer (mass %) | | | | | | | | |
| Evalu- | Initial water contact angle (degrees) | 5.7 | 6.5 | 7.4 | 8.4 | 8.4 | 5.2 | 5.8 | 5.6 |
| ation | Water contact angle after 1 week at | 8.3 | 6.9 | 11.2 | 13.6 | 19.8 | 5.3 | 6.0 | 7.8 |
| | 90° C. (degrees) | | | | | | | | |
| | Δ CA (deg) | 2.6 | 0.4 | 3.8 | 5.2 | 11.4 | 0.1 | 0.2 | 2.2 |
| | Initial total light transmittance (%) | 91.0 | 91.1 | 91.2 | 90.0 | 90.0 | 90.9 | 90.6 | 90.8 |
| | Initial haze (%) | 0.84 | 0.79 | 0.77 | 0.65 | 0.73 | 1.07 | 0.87 | 0.88 |
| | Total light transmittance (%) after | 90.9 | 91.1 | 91.2 | 90.0 | 90.0 | 90.8 | 90.6 | 90.8 |
| | abrasion test | | | | | | | | |
| | Haze (%) after abrasion test | 0.85 | 0.77 | 0.73 | 0.51 | 0.78 | 1.00 | 0.84 | 0.80 |
| | Δ Haze (%) | 0.01 | −0.02 | −0.04 | −0.14 | 0.05 | −0.07 | −0.03 | −0.08 |

| | | | Ex | Ex. | Ex. | Ex. | Ex. | Ex. | Ex. |
|---|---|---|---|---|---|---|---|---|---|
| | | | 9 | 10 | 11 | 12 | 13 | 14 | 15 |
| First | Inorganic | Nanoparticle dispersion 1 | 49.7 | 49.7 | 49.7 | 49.7 | 49.7 | 49.7 | 49.7 |
| layer | nanoparticles | Nanoparticle dispersion 2 | 22.7 | 22.7 | 22.7 | 22.7 | 22.7 | 22.7 | 22.7 |
| | | Nanoparticle dispersion 3 | — | — | — | — | — | — | — |
| | | Nanoparticle dispersion 4 | — | — | — | — | | — | — |
| | | (no reactive group) | | | | | | | |
| | | Nanoparticle dispersion 5 | — | — | — | — | — | — | — |
| | | (no reactive group) | | | | | | | |
| | Binder | Monomer 1 (trifunctional) | — | — | — | — | — | — | — |
| | precursor | Monomer 2 (trifunctional) | 4.9 | — | — | — | — | — | — |
| | | Monomer 3 (tetrafunctional) | — | 7.9 | 4.9 | — | — | — | — |
| | | Monomer 4 (hexafunctional) | — | — | — | 7.9 | 4.9 | — | — |
| | | Monomer 5 (trifunctional) | — | — | — | — | — | 7.9 | 4.9 |
| | | Monomer 6 (tetrafunctional) | — | — | — | — | — | — | — |
| | | Monomer 7 (trifunctional) | — | — | — | — | — | — | — |
| | | Monomer 8 (trifunctional) | — | — | — | — | — | — | — |
| | | Monomer 9 (trifunctional) | — | — | — | — | — | — | — |
| | | Monomer 10 (tetrafunctional) | — | — | — | — | — | — | — |
| | | Monomer 11 (bifunctional) | — | — | — | — | — | — | — |
| | | Monomer 12 (bifunctional) | 4.9 | 2.0 | 4.9 | 2.0 | 4.9 | 2.0 | 4.9 |
| | Photopolymerization | Initiator 1 | 1.2 | 1.2 | 1.2 | 1.2 | 1.2 | 1.2 | 1.2 |
| | initiator | Initiator 2 | — | — | — | — | — | — | — |
| | Surface modifier | SAC | — | — | — | — | — | — | — |
| | Solvent | MIPA | 16.6 | 16.6 | 16.6 | 16.6 | 16.6 | 16.6 | 16.6 |
| | | Water | — | — | — | — | — | — | — |
| | | ETOH | — | — | — | — | — | — | — |

| | | | | | | | | |
|---|---|---|---|---|---|---|---|---|
| | Total | 100 | 100 | 100 | 100 | 100 | 100 | 100 |
| | Film thickness of first layer (μm) | 3.2 | 3.6 | 3.3 | 3.4 | 2.9 | 3.1 | 2.8 |
| | Content of inorganic nanoparticles | 73 | 73 | 73 | 73 | 73 | 73 | 73 |
| | in first layer (mass %) | | | | | | | |
| Evalu- | Initial water contact angle (degrees) | 8.1 | 6.5 | 8.1 | 6.3 | 8.1 | 7.3 | 7.8 |
| ation | Water contact angle after 1 week at | 10.8 | 8.2 | 11.3 | 7.5 | 10 5 | 11.0 | 17.1 |
| | 90° C. (degrees) | | | | | | | |
| | Δ CA (deg) | 2.7 | 1.7 | 3.2 | 1.2 | 2.4 | 3.7 | 9.3 |
| | Initial total light transmittance (%) | 90.7 | 90.9 | 90.7 | 90.8 | 90.8 | 91.0 | 91.0 |
| | Initial haze (%) | 0.64 | 0.75 | 0.65 | 0.82 | 0.68 | 0.69 | 0.86 |
| | Total light transmittance (%) after | 90.6 | 90.8 | 90.6 | 91.0 | 90 7 | 91.2 | 91.2 |
| | abrasion test | | | | | | | |
| | Haze (%) after abrasion test | 0.68 | 0.74 | 0.67 | 0.83 | 0.71 | 0 79 | 0.73 |
| | Δ Haze (%) | 0.04 | −0.01 | 002 | 0.01 | 0.02 | 0.10 | −0.13 |

TABLE 3

| | | | Ex. | Ex. | Ex. | Ex. | Ex. | Ex. | Ex. | Ex. |
|---|---|---|---|---|---|---|---|---|---|---|
| | | | 16 | 17 | 18 | 19 | 20 | 21 | 22 | 23 |
| First | Inorganic | Nanoparticle dispersion 1 | 49.7 | 49.7 | 49.7 | 49.7 | 49.7 | 66.7 | 36.4 | 49.7 |
| layer | nanoparticles | Nanoparticle dispersion 2 | 22.7 | 22.7 | 22.7 | 22.7 | 22.7 | — | 16.6 | 22.7 |
| | | Nanoparticle dispersion 3 | — | — | — | — | — | 24.1 | — | — |
| | | Nanoparticle dispersion 4 | — | — | — | — | — | — | — | — |
| | | (no reactive group) | | | | | | | | |
| | | Nanoparticle Dispersion 5 | — | — | — | — | — | — | — | — |
| | | (no reactive group) | | | | | | | | |
| | Binder | Monomer 1 (trifunctional) | — | — | — | — | — | — | — | — |
| | precursor | Monomer 2 (trifunctional) | — | — | — | — | — | — | — | — |
| | | Monomer 3 (tetrafunctional) | — | — | — | — | — | — | — | — |
| | | Monomer 4 (hexafunctional) | — | — | — | — | — | — | — | — |
| | | Monomer 5 (trifunctional) | — | — | — | — | — | — | — | — |
| | | Monomer 6 (tetrafunctional) | — | — | — | — | — | — | — | — |
| | | Monomer 7 (trifunctional) | — | — | 7.9 | 4.9 | 3.0 | 1.8 | 5.3 | — |
| | | Monomer 8 (trifunctional) | — | — | — | — | — | — | — | 4.9 |
| | | Monomer 9 (trifunctional) | — | — | — | — | — | — | — | — |
| | | Monomer 10 (tetrafunctional) | — | — | — | — | — | — | — | — |
| | | Monomer 11 (bifunctional) | — | — | — | — | — | — | — | — |
| | | Monomer 12 (bifunctional) | 2.0 | 4.9 | 2.0 | 4.9 | 6.9 | 4.2 | 12.5 | 4.9 |
| | Photopolymerization | Initiator 1 | 1.2 | 1.2 | 1.2 | 1.2 | 1.2 | 1.2 | 1.2 | 1.2 |
| | initiator | Initiator 2 | — | — | — | — | — | — | — | — |
| | Surface modifier | SAC | — | — | — | — | — | — | — | — |
| | Solvent | MIPA | 16.6 | 16.6 | 16.6 | 16.6 | 166 | 2.1 | 28.0 | 16.6 |
| | | Water | — | — | — | — | — | — | — | — |
| | | ETOH | — | — | — | — | — | — | — | — |
| | Total | | 100 | 100 | 100 | 100 | 100 | 100 | 100 | 100 |
| | Film thickness of first layer (μm) | | 3.6 | 2.8 | 3.2 | 3.1 | 3.0 | 2.8 | 2.7 | 2.7 |
| | Content of inorganic nanoparticles | | 73 | 73 | 73 | 73 | 73 | 83 | 53 | 73 |
| | in first layer (mass %) | | | | | | | | | |
| Evalu- | Initial water contact angle (degrees) | | 5.9 | 7.4 | 8.2 | 7.0 | 7.0 | 5.9 | 7.2 | 8.0 |
| ation | Water contact angle after 1 week at | | 7.9 | 8.9 | 9.0 | 11.6 | 10.0 | 6.2 | 17.0 | 9.1 |
| | 90° C. (degrees) | | | | | | | | | |
| | Δ CA (deg) | | 2.0 | 1.5 | 0.8 | 4.6 | 3.0 | 0.3 | 9.8 | 1.1 |
| | Initial total light transmittance (%) | | 90.9 | 91.1 | 90.8 | 91.0 | 91.3 | 91.2 | 91.0 | 91.2 |
| | Initial haze (%) | | 0.76 | 0.93 | 0.89 | 0.63 | 0.65 | 0.81 | 0.77 | 0.70 |
| | Total light transmittance (%) after | | 91.1 | 91.1 | 90.8 | 91.2 | 91.2 | 91.1 | 90.9 | 91.3 |
| | abrasion test | | | | | | | | | |
| | Haze (%) after abrasion test | | 0.83 | 0.82 | 0.91 | 0.65 | 0.65 | 0.83 | 0.82 | 0.69 |
| | Δ Haze (%) | | 0.07 | −0.11 | 0.02 | 0.02 | 0.00 | 0.02 | 0.05 | −001 |
| | | | Ex. | Ex. | Ex. | Ex. | Ex. | Ex. | Ex. | Ex. |
| | | | 24 | 25 | 26 | 27 | 28 | 29 | 30 | 31 |
| First | Inorganic | Nanoparticle dispersion 1 | 49.7 | 49.7 | 66.7 | 36.4 | 49.7 | 49.7 | 66.7 | 36.4 |
| layer | nanoparticles | Nanoparticle dispersion 2 | 22.7 | 22.7 | — | 16.6 | 22.7 | 22.7 | — | 16.6 |
| | | Nanoparticle dispersion 3 | — | — | 24.1 | — | — | — | 241 | — |
| | | Nanoparticle dispersion 4 | — | — | — | — | — | — | — | — |
| | | (no reactive group) | | | | | | | | |
| | | Nanoparticle Dispersion 5 | — | — | — | — | — | — | — | — |
| | | (no reactive group) | | | | | | | | |
| | Binder | Monomer 1 (trifunctional) | — | — | — | — | — | — | — | — |
| | precursor | Monomer 2 (trifunctional) | — | — | — | — | — | — | — | — |
| | | Monomer 3 (tetrafunctional) | — | — | — | — | — | — | — | — |
| | | Monomer 4 (hexafunctional) | — | — | — | — | — | — | — | — |
| | | Monomer 5 (trifunctional) | — | — | — | — | — | — | — | — |
| | | Monomer 6 (tetrafunctional) | — | — | — | — | — | — | — | — |
| | | Monomer 7 (trifunctional) | — | — | | — | — | — | — | — |
| | | Monomer 8 (trifunctional) | — | — | — | — | — | — | — | — |
| | | Monomer 9 (trifunctional) | 4.9 | 3.0 | 1.8 | 5.3 | — | — | — | — |
| | | Monomer 10 (tetrafunctional) | — | — | — | — | 4.9 | 3.0 | 1.8 | 5.3 |
| | | Monomer 11 (bifunctional) | — | — | — | — | — | — | — | — |
| | | Monomer 12 (bifunctional) | 4.9 | 6.9 | 4.2 | 12.5 | 4.9 | 6.9 | 4.2 | 12.5 |
| | Photopolymerization | Initiator 1 | 1.2 | 1.2 | 1.2 | 1.2 | 1.2 | 1.2 | 1.2 | 1.2 |
| | initiator | Initiator 2 | — | — | — | — | — | — | — | — |
| | Surface modifier | SAC | — | — | — | — | — | — | — | — |
| | Solvent | MIPA | 16.6 | 16.6 | 2.1 | 28.0 | 16.6 | 16.6 | 2.1 | 28.0 |
| | | Water | — | — | — | — | — | — | — | — |
| | | ETOH | — | — | — | — | — | — | — | — |

| | | | | | | | | | |
|---|---|---|---|---|---|---|---|---|---|
| | Total | 100 | 100 | 100 | 100 | 100 | 100 | 100 | 100 |
| | Film thickness of first layer (μm) | 2.4 | 2.5 | 2.8 | 3.0 | 2.8 | 2.5 | 3.1 | 2.7 |
| | Content of inorganic nanoparticles | 73 | 73 | 83 | 53 | 73 | 73 | 83 | 53 |
| | in first layer (mass %) | | | | | | | | |
| Evalu- | Initial water contact angle (degrees) | 8.9 | 8.2 | 7.7 | 7.2 | 10.4 | 8.2 | 9.0 | 9.8 |
| ation | Water contact angle after 1 week at | 15.7 | 16.3 | 9.9 | 14.6 | 15.8 | 15.0 | 11.4 | 22.2 |
| | 90° C. (degrees) | | | | | | | | |
| | Δ CA (deg) | 6.8 | 8.1 | 2.2 | 7.4 | 5.4 | 6.7 | 2.4 | 12.5 |
| | Initial total light transmittance (%) | 91.1 | 90.0 | 91.1 | 91.0 | 91.2 | 91.1 | 91.2 | 91.0 |
| | Initial haze (%) | 0.66 | 0.84 | 0.77 | 0.77 | 0.76 | 0.73 | 0.76 | 0.68 |
| | Total light transmittance (%) after | 91.1 | 89.9 | 91.1 | 90.9 | 91.1 | 91.0 | 91.2 | 91.0 |
| | abrasion test | | | | | | | | |
| | Haze (%) after abrasion test | 0.71 | 0.84 | 0.77 | 0.82 | 0.81 | 0.78 | 0.80 | 0.70 |
| | Δ Haze (%) | 0.05 | −0.01 | 0.00 | 0.05 | 0.04 | 0.05 | 0.04 | 0.02 |

TABLE 4

| | | | Comparative | Comparative | Comparative | Comparative | Comparative |
|---|---|---|---|---|---|---|---|
| | | | Example 1 | Example 2 | Example 3 | Example 4 | Example 5 |
| First | Inorganic | Nanoparticle dispersion 1 | 49.7 | 49 7 | 49.7 | — | — |
| layer | nanoparticles | Nanoparticle dispersion 2 | 22.7 | 22.7 | 22.7 | — | — |
| | | Nanoparticle dispersion 3 | — | — | — | — | — |
| | | Nanoparticle dispersion 4 | — | — | — | 27.9 | 31.6 |
| | | (no reactive group) | | | | | |
| | | Nanoparticle Dispersion 5 | — | — | — | 21.5 | 24.4 |
| | | (no reactive group) | | | | | |
| | Binder | Monomer 1 (trifunctional) | — | — | 2.0 | 2.5 | 1.5 |
| | precursor | Monomer 2 (trifunctional) | — | — | — | — | — |
| | | Monomer 3 (tetrafunctional) | — | — | — | — | — |
| | | Monomer 4 (hexafunctional) | — | — | — | — | — |
| | | Monomer 5 (trifunctional) | — | — | — | — | — |
| | | Monomer 6 (tetrafunctional) | — | — | — | — | — |
| | | Monomer 7 (trifunctional) | — | — | — | — | — |
| | | Monomer 8 (trifunctional) | — | — | — | — | — |
| | | Monomer 9 (trifunctional) | — | — | — | — | — |
| | | Monomer 10 (tetrafunctional) | — | — | — | — | — |
| | | Monomer 11 (bifunctional) | 9.9 | — | — | 2.5 | 1.5 |
| | | Monomer 12 (bifunctional) | | 9.9 | 7.9 | — | — |
| | Photopolymerization | Initiator 1 | 1.2 | 1.2 | 1.2 | — | — |
| | initiator | Initiator 2 | — | — | — | 0.6 | 0.6 |
| | Surface modifier | SAC | — | — | — | — | 0.1 |
| | Solvent | MIPA | 16.6 | 16.6 | 16.6 | — | — |
| | | Water | — | — | — | 9.2 | 35.8 |
| | | ETOH | — | — | — | 35.8 | 4.6 |

| | | | | | | |
|---|---|---|---|---|---|---|
| | Total | 100 | 100 | 100 | 100 | 100 |
| | Film thickness of first layer (μm) | 3.0 | 3.2 | 3.1 | 1.8 | 1.9 |
| | Content of inorganic nanoparticles | 73 | 73 | 73 | 73 | 83 |
| | in first layer (mass %) | | | | | |
| Evalu- | Initial water contact angle (degrees) | 6.9 | 12.5 | 7.2 | 10.1 | 16.8 |
| ation | Water contact angle after 1 week at | 37.2 | 47.8 | 32.6 | 43.9 | 48.5 |
| | 90° C. (degrees) | | | | | |
| | Δ CA (deg) | 30.3 | 35.3 | 25.4 | 33.8 | 31.7 |
| | Initial total light transmittance (%) | 91.1 | 91.3 | 91.5 | 88.4 | 85.9 |
| | Initial haze (%) | 1.63 | 0.94 | 0.84 | 16.68 | 47.44 |
| | Total light transmittance (%) after | 91.1 | 91.3 | 91.6 | 88.4 | 85.7 |
| | abrasion test | | | | | |
| | Haze (%) after abrasion test | 0.78 | 0.92 | 0.73 | 17.34 | 47.67 |
| | Δ Haze (%) | −0.85 | −0.02 | −0.11 | 0.66 | 0.23 |

It will be apparent to those skilled in the art that various modifications can be made to the embodiments and the examples described above without departing from the basic principles of the present invention. In addition, it will be apparent to those skilled in the art that various improvements and modifications of the present invention can be carried out without departing from the spirit and the scope of the present invention.

### REFERENCE SIGNS LIST

100 Laminate
101 Substrate
103 First layer
105 Second layer
107 Binder
109 Inorganic nanoparticle

1. A laminate comprising: a substrate;
a first layer disposed on at least one surface of the substrate, the first layer comprising a binder and an inorganic nanoparticle; and
a second layer that is hydrophilic, the second layer being disposed on the first layer,
the binder containing a cured product of a binder precursor, the binder precursor containing 30 mass % or greater of a tri- or higher functional (meth)acrylate monomer relative to a total amount of the binder, and the inorganic nanoparticle having a (meth)acryloyl group.

2. The laminate according to claim 1, wherein the first layer contains the inorganic nanoparticle in an amount of more than 50 mass % based on the total weight of the first layer.

3. The laminate according to claim 1, wherein the inorganic nanoparticle is at least one kind of particle selected from the group consisting of silica, alumina, zinc oxide, zirconium oxide, tin-doped indium oxide, and antimony-doped tin oxide.

4. The laminate according to claim 1, wherein the second layer contains a zwitterionic silane.

5. The laminate according to claim 1, wherein the substrate is a transparent substrate.

6. The laminate according to claim 5, having a haze value of 10% or less.

7. The laminate according to claim 1, further comprising an adhesive layer disposed on a surface of the substrate that is opposite to a side of the second layer.

8. An article comprising the laminate described in claim 1.

9. The article according to claim 8, which is used as a medical device.

10. The article according to claim 9, which is used as a microfluidic chip.

11. A coating composition comprising a binder precursor and an inorganic nanoparticle, the binder precursor containing 30 mass % or greater of a tri- or higher functional (meth)acrylate monomer relative to a total amount of the binder precursor, and the inorganic nanoparticle having a (meth)acryloyl group,
wherein the coating composition forms a layer on which a hydrophilic layer is applied.

12. The composition according to claim 11, wherein the (meth)acrylate monomer has a (meth)acryloyl equivalent from 80 to 700.

13. The composition according to claim 11, wherein the (meth)acrylate monomer is at least one selected from the group consisting of tris[2-((meth)acryloyloxy)ethyl] isocyanurate, trimethylolpropane tri(meth)acrylate, pentaerythritol tri(meth)acrylate, pentaerythritol tetra(meth)acrylate, pentaerythritol alkoxy tetra(meth)acrylate, dipentaerythritol hexa(meth)acrylate, ethoxylated trimethylolpropane tri(meth)acrylate, ethoxylated pentaerythritol tetra(meth)acrylate, a tri- or higher functional urethane (meth)acrylate, and a tri- or higher functional epoxy (meth)acrylate.

14. The composition according to claim 11, comprising the inorganic nanoparticle in an amount greater than 50 parts by mass based on 100 parts by mass of a solid content of the composition.
